(19) United States
(12) Patent Application Publication
(10) Pub. No.: US 2013/0264400 A1
(43) Pub. Date: Oct. 10, 2013

(54) Nozzle for Dispensing Foam Product

(71) Applicant: William R. Crandley, Sebastian, FL (US)

(72) Inventor: William R. Crandley, Sebastian, FL (US)

(73) Assignee: TURNING TIDE, LLC, Sebastian, FL (US)

(21) Appl. No.: 13/439,359

(22) Filed: Apr. 4, 2012

(51) Int. Cl. A62C 31/02

(52) U.S. Cl. 239/589

(57) ABSTRACT

The invention includes a triangular or trapezoidal attachment nozzle for a straw extender tube used with aerosol foaming canned products. The invention also includes a foam distribution assembly system comprising the nozzle, an aerosol can, and a straw extender tube and a method for distributing foam product using such system. When the extender tube is correctly inserted, and the aerosol can is discharged, the foam from the can travels from the aerosol can through the extender tube, and then into the triangular or trapezoidal nozzle. The foam then fills an interior expansion space in the nozzle that gradually widens, and exits the nozzle at its widest point. As it exits the nozzle, rather than being a cylindrical shape, the foam exits in a rectangular sheet shape, which is more fitting for applications such as applying insulation.

### FIELD OF THE INVENTION

Aspects of the invention relate generally to improvements in dispensing foam products from aerosol cans.

### BACKGROUND

Foamed liquid products are commonly distributed to consumers in aerosol cans. Everything from shaving cream to foam insulation to food products to silly string are distributed to consumers in aerosol cans, which allow for the mixing of the liquid with the suspended gas prior to discharge as a foam. Many of the foams distributed in such cans are self-expanding; that is, they are expected to increase in volume significantly after discharge from the aerosol can. When dispensed from the standard push-button aerosol nozzle, such self-expanding foams are difficult to control, both in placing the foam in a specific location and controlling its volume expansion.

For such self-expanding foams, oftentimes in addition to the standard push-button nozzle of the can, an extender tube or “straw” attachment is included. This straw attachment has a consistent circular diameter to limit expansion of the foam until it is discharged from the end of the tube. This allows the user of the product to have greater control in directing the product toward the intended location. However, with such straw attachments, the foam is still discharged from a small diameter tube, and when a great deal of foam product needs to be discharged, it takes quite a while to cover a large surface area with the product. If a large or flat surface needs to be covered by the foam, the user oftentimes needs to use a circular or back-and-forth motion, which does not provide particularly even coverage of the foam. When, for example, dispensing a foam insulation that later hardens to a solid in this manner, oftentimes there is too much product dispensed, which requires cutting or shaving of the foam after it hardens.

There exists a need for a foam dispensing system from aerosol cans that can provide a wider, more controlled flow of foam than is typically dispensed from a straw attachment.

### SUMMARY OF THE INVENTION

The present invention relates to an attachment that fits on a straw extender tube that is traditionally used with aerosol foaming canned products, such as foam insulation. This attachment is a nozzle that is approximately triangular or trapezoidal in shape. The straw extender tube slides into the narrower end of the approximately triangular or trapezoidal nozzle. When the extender tube is correctly inserted, and the aerosol can is discharged, the foam from the can travels from the aerosol can through the extender tube, and then into the triangular or trapezoidal nozzle. The foam then fills an interior expansion space in the nozzle that gradually widens, and exits the nozzle at its widest point. As it exits the nozzle, rather than being a cylindrical shape, the foam exits in a rectangular sheet shape, which is more fitting for applications such as applying insulation.

The present invention also relates to an aerosol foam distribution assembly comprising an aerosol can with a foamable liquid, a straw extender on the exit nozzle to the aerosol can, and a triangular or trapezoidal attachment or end to the straw extender. The present invention also relates to a method of distributing a foam using such a system or such an attachment.

### BRIEF DESCRIPTION OF THE DRAWINGS

The above and other objects, features, and advantages of the invention will become more apparent from the following description of certain preferred embodiments thereof, when taken in conjunction with the accompanying drawings in which:

FIG. 1 depicts a top view of one triangular nozzle embodiment of the invention.

FIG. 2 depicts an angled (˜45°) cross section view of a triangular nozzle embodiment of the invention.

FIG. 3 depicts a top view of an embodiment of the invention, with a straw attachment inserted.

FIG. 4 depicts a side view of an aerosol foam distribution assembly embodiment depicting a nozzle straw and aerosol can, in accordance with an embodiment of the invention.

FIG. 5 depicts at top view of an aerosol foam distribution assembly embodiment depicting a nozzle as inserted onto a straw attachment on an aerosol can, in accordance with an embodiment of the invention.

### DETAILED DESCRIPTION OF PREFERRED EMBODIMENTS

The present invention now will be described more fully hereinafter with reference to the accompanying drawings, in which preferred embodiments of the invention are shown. The invention may, however, be embodied in many different forms and should not be construed as limited to the embodiments set forth herein; rather, these embodiments are provided so that this disclosure will be thorough and complete and convey the scope of the invention to those skilled in the art. Like numbers refer to like elements throughout.

Aerosol cans of self-expanding foams with a standard push-button nozzle can often include an extender tube or “straw” attachment 200. This straw attachment 200 usually has a consistent circular diameter to limit expansion of the foam until it is discharged from the end of the tube. The present invention includes a nozzle 100 that is approximately triangular or trapezoidal in shape.

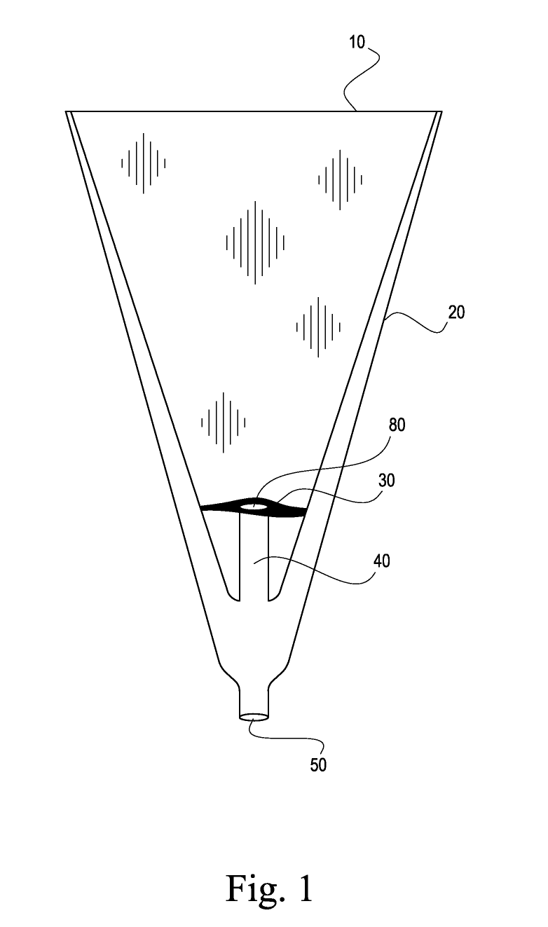

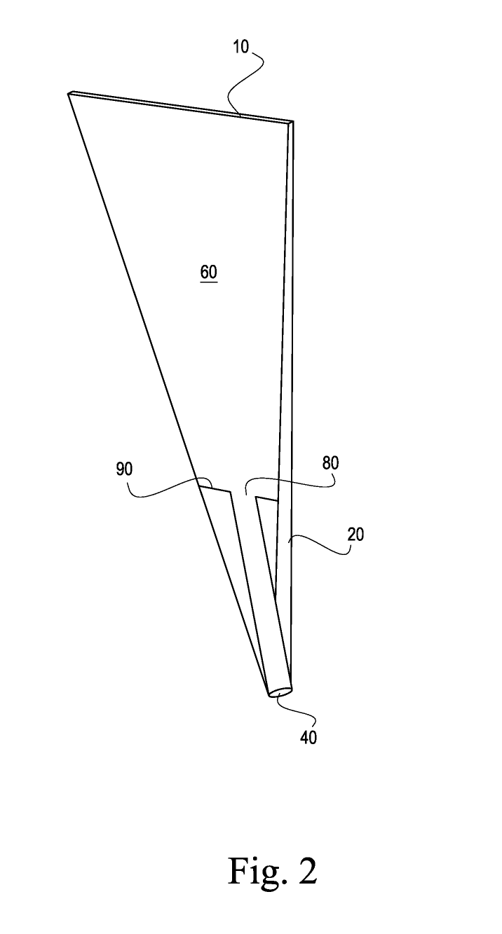

An approximately triangular nozzle according to an embodiment of the invention is shown in FIG. 1 and FIG. 2. The nozzle is comprised of a narrower straw insertion point 50 on one end, and a discharge point 10 on the other end. Using the triangular analogy, the discharge point would be the base of the approximately isosceles triangle, whereas the straw insertion point would be at the opposite angle from the base. In this embodiment, a cylindrical orifice extends from the straw insertion point through the center of the nozzle until the orifice end point 80. The straw orifice 40 is designed to snugly fit the straw attachment 200 such that it can be inserted, but it is kept firmly in place without any significant lateral movement of the straw attachment. Thus, the diameter of the straw orifice 40 should be only slightly larger in diameter than the outer diameter of the straw attachment 200 to be used. Preferably, the diameter of the straw orifice 40 is less than about 1/64 inch larger than the diameter of the straw attachment 200 to be used with it. In preferred embodiments, the length of the straw orifice is at least ¼ of the overall length of the nozzle, preferably at least ⅓ the overall length of the nozzle.

According to this embodiment, the exterior of the nozzle has a solid housing wall, with outer openings for only the straw insertion point 50 and the discharge point 10. However, between the orifice end point 80 and the discharge point 10, the interior of the nozzle is hollow, and this hollow area forms an expansion space 60. The expansion space is bounded by two side housing walls 20, a backflow wall 90 opposite the discharge point 10, and a dorsal and ventral wall. The two side housing walls flare out, which widens the expansion space. In a preferred embodiment, the height of the expansion space decreases as the side walls flare out; that is, as shown in FIG. 2, the distance between the dorsal and ventral walls at the backflow wall 90 is greater than the distance between the dorsal and ventral walls at the discharge point 10. This, the expansion space 60 widens and flattens from the orifice end point 80 to the discharge point 10. This provides a more controlled expansion of the foam as it exits the straw, which allows the user a more controlled disbursement of the foam when it exits at the discharge point. The discharge point 10 is an unobstructed opening.

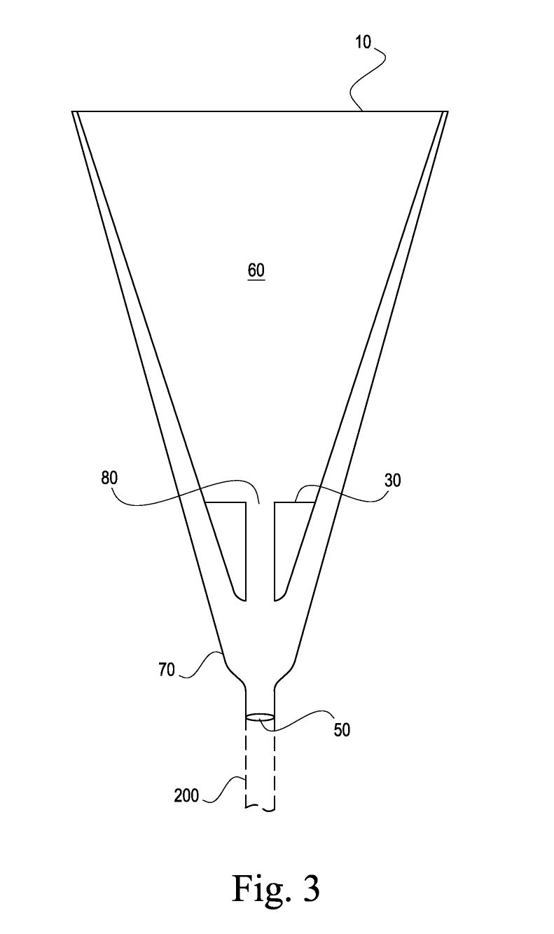

As shown in the embodiments shown in FIGS. 1 and 3, with a top-side cross section, the expansion space 60 is an approximately isosceles triangle. However, embodiments of the invention are not limited to merely this single shape, and the housing walls 20 may, for example more significantly curve outwards like a bell or fan. In a preferred embodiment of the invention as shown in FIG. 1, the width of the side housing walls 20 actually decreases from the backflow wall 90 to the discharge point, as the foam expands and the relative pressure of the foams decreases. Likewise, the width of the side housing walls in a preferred embodiment may be greater at the straw insertion point and near the straw orifice than at the backflow wall 90.

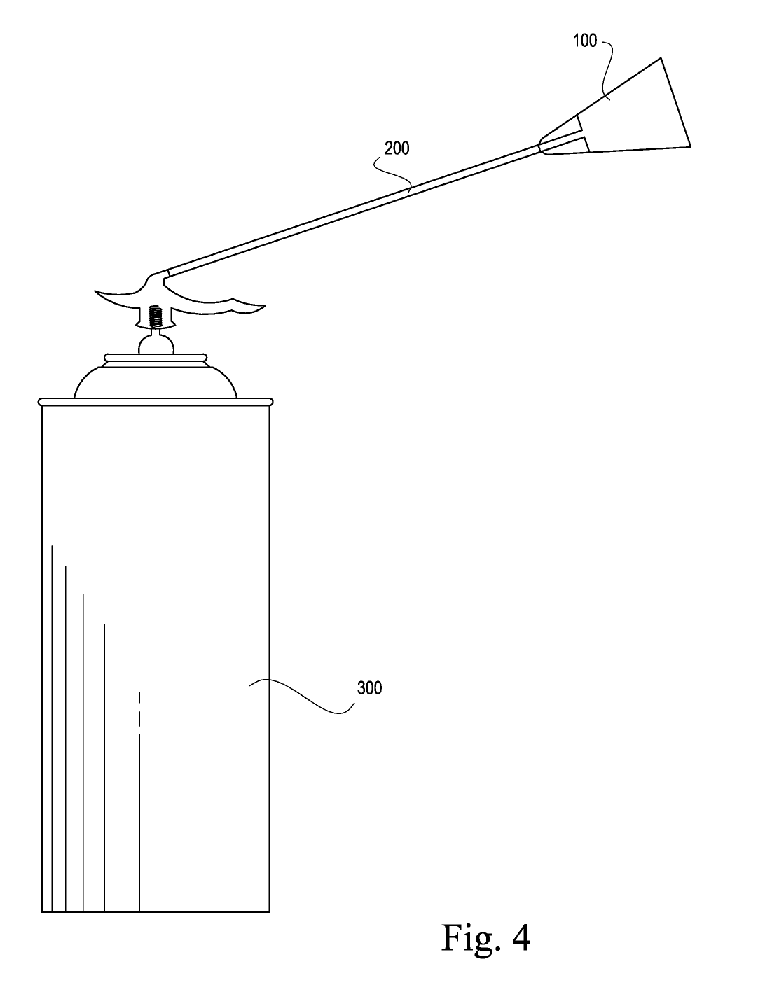

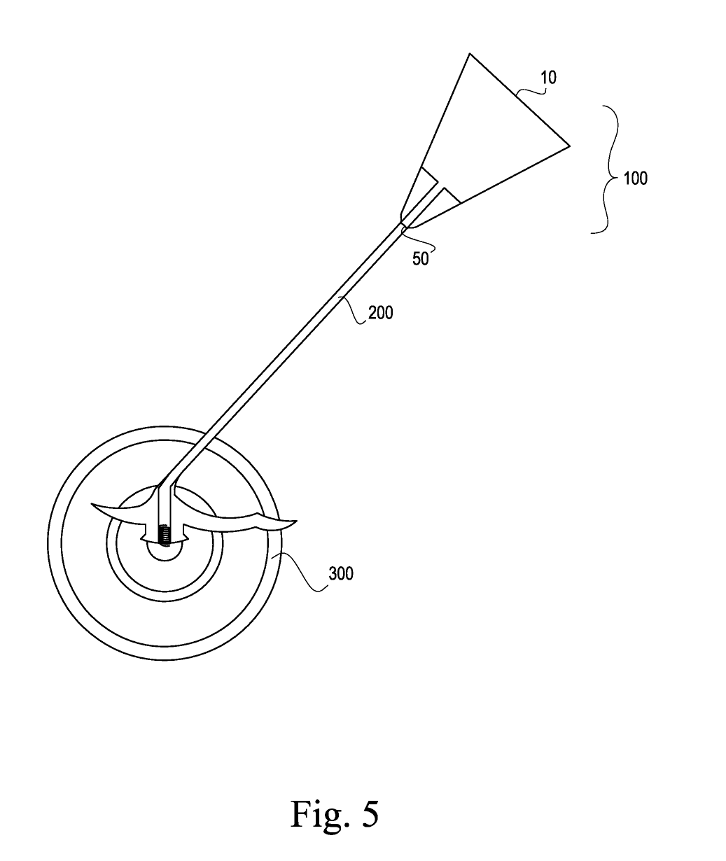

The invention further includes an aerosol can assembly comprising an aerosol can with a foam-producing product within, a straw attachment, and a nozzle as previously described. The nozzle may be used with a straw attachment 200 to deposit the foam in a rectangular or sheet shape, rather than as a string-like or tubular shape which would result from use of the straw attachment alone. As shown in FIG. 4 and FIG. 5, to assemble the nozzle 100 onto an aerosol can 300 with a straw attachment 200, the user would slide the straw insertion point 50 of the nozzle 100 onto one end of the straw attachment 200. The other end of the straw attachment would be inserted into the aerosol can's push button. The straw attachment 200 may be pushed into the nozzle 100, through the straw orifice 40 as depicted in FIGS. 1 and 2, which is a central channel within the nozzle. In some embodiments, the straw attachment 200 is inserted at least about ¼ of the total length of the nozzle; in other embodiments, the straw attachment 200 is inserted at least about ⅓ of the total length of the nozzle. The straw attachment may also in some embodiments be inserted through the center of the discharge end 10 and through the orifice end point 80 through the straw orifice 40 and out the straw insertion point 50. According to one preferred embodiment of the invention, the user would insert the straw attachment 200 fully through the straw orifice 40 until it hits the straw stop 30, which would naturally stop the straw and prevent further insertion of the straw attachment.

The straw stop or straw stop point present in some embodiments of the invention can be any means for impeding the further movement of the straw in the straw orifice or out to the expansion space. The straw stop may, for example, be a slight narrowing in the interior diameter of the straw orifice (as depicted in FIG. 1) at or near the orifice end point. Alternately, the straw stop may include one or more protrusions at or near the straw orifice end point. The straw stop may also include an additional part that is inserted on or along the straw attachment 200 or even integrated in the straw attachment that, for example, increases the outer diameter of the straw attachment at one end. Thus, if the end of the straw attachment 200 that does not have the straw stop attached is inserted into the discharge end 10 of the nozzle then through the orifice end point through the straw orifice 40 and pulled out the orifice end point 50, the increased diameter of the straw stop would then stop the straw from being able to be pulled further through once the straw stop hist the orifice end point 80

The straw extender tube slides into the narrower end of the approximately triangular or trapezoidal nozzle. When the extender tube is correctly inserted, and the aerosol can is discharged, the foam from the can travels from the aerosol can through the extender tube, and then into the approximately triangular or trapezoidal nozzle. The foam then fills the interior expansion space 60 in the nozzle that gradually widens, and exits the nozzle at the discharge point 10, its widest point. The discharge point 10 is unobstructed by baffles or additional turbulence inducers, such that the flow of the foam can be controlled. As it exits the nozzle, rather than being a cylindrical shape, the foam exits in a rectangular sheet shape, which is more fitting for applications such as applying insulation.

The invention further includes a process for distributing foam product such as foam insulation comprising first inserting a straw attachment into one end of a standard aerosol can and inserting a nozzle as previously described into another end of the straw attachment. The second step is pushing the button on the aerosol can to discharge the product (including propellant) into the straw orifice, where it then flows into the nozzle. The product fills the expansion space of the nozzle and then exits the nozzle in a rectangular sheet through the discharge point. The user directs the flow of the product by aiming the discharge point of the nozzle at the area that is to be covered by the product. The user may then optionally and if needed clean up excess product, or cut away excess product if needed. The user may also optionally disassemble the nozzle and straw from the aerosol can and clean it for reuse, by flushing it with water or an appropriate liquid.

The nozzle embodiments of the invention may be constructed of any suitable material, including various polymers, metals, and composites. Preferred materials of construction include materials that are compatible with plastic injection molding manufacturing processes, including nylon, various polyethylenes (such as HDPE, LDPE, and LLDPE), polyvinyl chloride, ABS, biopolymers, and polystyrene. One particularly preferred material of construction for injection molding of a nozzle according to the invention is linear low density polyethylene (LLDPE). Another particularly preferred material are biopolymers, such as those manufactured by Rex Plastics.

The dorsal and vestal walls (or top and bottom walls) of the expansion area may optionally be of identical size and shape. In such and embodiment, the nozzle may not have any independently defined “top side,” that is, either side may be used as a top side. Similarly, though referred to as top or bottom or dorsal or vestal walls, the nozzle may be attached to the straw attachment at any angle relative to the aerosol can. This is particularly helpful when trying to place the product in difficult-to-reach areas.

Alternately, the dorsal and vestal walls may also differ slightly in shape and dimensions. In one embodiment as shown in FIG. 4, the dorsal wall may be slightly longer than the vestal wall, such that the discharge point or discharge area, though rectangular in cross section, is angled.

In a preferred embodiment designed to be compatible with a straw extension that is 3/16 inch in diameter, the invention is approximately 3¼ inches in length from the straw insertion point 50 to the discharge point 10. In this embodiment, the invention is approximately 2 inches in width at the discharge point, and the height of the embodiment at both the straw insertion point and discharge point is approximately 3/16 inch interior height and 5/16 inch exterior height. Another embodiment is designed to be compatible with a straw extension that is 7/32 inch in diameter.

In a preferred embodiment example, a nozzle adapter as previously described is used with self-propelling polyurethane insulation and the standard straw extender according to the invention. The polyurethane insulation is designed to be applied to a multitude of surfaces as a foam, adhere to the surface, and solidify. The invention targets the application surface with a slower, wider, and more controlled even flow of product in order to substantiate a cleaner, stronger, and more efficient means of applying the foam product. The nozzle is attached to the straw extender by placing the straw extender into the tight-fitting straw orifice, and the other end of the straw extender is inserted into the aerosol can of polyurethane insulation to form an insulation application apparatus. The straw is inserted approximately one-third of the total length of the nozzle. The foam is discharged into the nozzle and expands (widening in width and narrowing in height) to fill the expansion space. While holding down the button on the aerosol can, the user directs the discharge point (also referred to as the discharge space) at the intended location for the foam. The foam is discharged from the nozzle at the discharge point, which is a slit opening. The insulation application apparatus may be directed in a line, to discharge a sheet of foam that is discharged at the width of the discharge point but further expands when discharged. This allows for a more uniformly discharged foam that in turn leaves fewer to no gaps when fully expanded and solidified. Oftentimes, application of the foam in this manner requires little to no cutting or shaving of the solidified insulation, as opposed to what is typical when using just the aerosol can or the aerosol can plus straw extender alone. It also presents a smoother solidified insulation surface that is more uniform and less porous. This translates into a much better paintable surface, less penetration of cool or warm air, lower likelihood of breach of the surface by insects and rodents, and better control of moisture and mold.

The dimensions of the various parts of the nozzle embodiments may be adjusted to fit the size and pressure of the aerosol can, its contents, and the appropriate straw attachment. In one example nozzle embodiment built for use with foam insulation, the total length of the triangular nozzle is about 2.5 inches, the width of the discharge end is about 2 inches, and the length of the straw orifice is about 1 inch. Thus, the preferred ratio of the overall length to straw orifice length is preferably 4:1 to 2:1. The ratio of the preferred nozzle length to width at the discharge end is appropriately 1:2 to 12:1, more preferably 1:2 to 4:1, most preferably 1:1 to 3:1.

It should be emphasized that the above-described embodiments of the present disclosure are merely possible examples of implementations, merely set forth for a clear understanding of the principles of the disclosed systems and methods. Many variations and modifications may be made to the above-described embodiment(s) without departing substantially from the disclosed principles of the systems and methods. All such modifications and variations are intended to be included herein within the scope of this disclosure and the present disclosure and protected by the following claims.

That which is claimed:

1. An aerosol foam expansion nozzle comprising:
a cylindrical straw orifice, with a straw insertion point on one end and an orifice end point on the other end,
an expansion space attached to the cylindrical straw orifice, comprising a top and bottom walls, two side walls, and a backflow wall, and
a discharge surface opening opposite the backflow wall and orifice end point,
wherein the cylindrical straw orifice is attached such that the orifice end point is an opening in the backflow wall, and
wherein the side walls of the expansion space flare outwards, such that the distance between the side walls at the discharge surface opening is greater than the distance between the side walls at the backflow wall.

2. The nozzle as claimed in claim 1, wherein the discharge surface opening is unobstructed.

3. The nozzle as claimed in claim 1, wherein the distance between the top and bottom walls at the backflow wall is greater than the distance between the top and bottom walls at the discharge surface opening.

4. The nozzle as claimed in claim 1, further comprising a straw stop at the orifice end point.

5. The nozzle as claimed in claim 1, wherein top and bottom walls, side walls, and backflow walls, and cylindrical straw orifice are comprised of a rigid material.

6. The nozzle as claimed in claim 1, wherein the length of the straw orifice is at least ¼ of the length of the nozzle.

7. The nozzle as claimed in claim 1, wherein said side walls, backflow wall, and discharge surface opening define an approximately isosceles trapezoidal shape.

8. The nozzle as claimed in claim 1, wherein said nozzle is comprised of a rigid, plastic injection molded polymer.

9. The nozzle as claimed in claim 8, wherein said nozzle is comprised of plastic injection molded LLDPE.

10. An aerosol foam distribution assembly comprising:
an aerosol can filled with liquid foam product and comprising a push button distributor,
a straw extender attached to the push button distributor, and
a flat nozzle attached to said straw extender opposite the push button distributor,
said flat nozzle comprising:
a cylindrical straw orifice, with a straw insertion point on one end and an orifice end point on the other end,
an expansion space attached to the cylindrical straw orifice, comprising a top and bottom walls, two side walls, and a backflow wall, and
a discharge surface opening opposite the backflow wall and orifice end point, wherein the cylindrical straw orifice is attached such that the orifice end point is an opening in the backflow wall, and
wherein the side walls of the expansion space flare outwards, such that the distance between the side walls at the discharge surface opening is greater than the distance between the side walls at the backflow wall.

11. The nozzle as claimed in claim 10, wherein the discharge surface opening is unobstructed.

12. The nozzle as claimed in claim 10, wherein the distance between the top and bottom walls at the backflow wall is greater than the distance between the top and bottom walls at the discharge surface opening.

13. The nozzle as claimed in claim 10, wherein top and bottom walls, side walls, and backflow walls, and cylindrical straw orifice are comprised of a rigid material.

14. The nozzle as claimed in claim 10, wherein the length of the straw orifice is at least ¼ of the length of the nozzle.

15. The nozzle as claimed in claim 10, wherein said side walls, backflow wall, and discharge surface opening define an approximately isosceles trapezoidal shape.

16. The nozzle as claimed in claim 10, wherein said nozzle is comprised of a rigid, plastic injection molded polymer.

17. The nozzle as claimed in claim 10, further comprising a straw stop at the orifice end point.

18. The nozzle as claimed in claim 17, wherein the straw stop comprises a narrowing of the diameter of the orifice end point

19. A method of distributing a foam product from an aerosol can comprising liquid product and a straw-shaped distribution nozzle, said method comprising:
(a) attaching an additional flat nozzle to said straw shaped distribution nozzle, said flat nozzle comprising:
a cylindrical straw orifice, with a straw insertion point on one end and an orifice end point on the other end,
an expansion space attached to the cylindrical straw orifice, comprising a top and bottom walls, two side walls, and a backflow wall, and
a discharge surface opening opposite the backflow wall and orifice end point,
wherein the cylindrical straw orifice is attached such that the orifice end point is an opening in the backflow wall, and
wherein the side walls of the expansion space flare outwards, such that the distance between the side walls at the discharge surface opening is greater than the distance between the side walls at the backflow wall, and
wherein said flat nozzle is attached to said straw shaped distribution nozzle by sliding said straw shaped distribution nozzle into the straw insertion point to said orifice end point,
(b) discharging said foam product from the aerosol can through the straw shaped distribution nozzle into the flat nozzle, and out of the discharge surface opening of the flow nozzle.
